(19) United States
(12) Patent Application Publication
(10) Pub. No.: US 2023/0418688 A1
(43) Pub. Date: Dec. 28, 2023

(54) ENERGY EFFICIENT COMPUTING WORKLOAD PLACEMENT

(71) Applicant: Red Hat, Inc., Raleigh, NC (US)

(72) Inventors: Chen Wang, Chappaqua, NY (US); Huamin Chen, Westboro, MA (US)

(21) Appl. No.: 17/851,409

(22) Filed: Jun. 28, 2022

(51) Int. Cl. G06F 9/50

(52) U.S. Cl. CPC G06F 9/5094; G06F 9/5083; G06F 9/505; G06F 9/5038

(57) ABSTRACT

A method includes obtaining an energy consumption profile for a plurality of computing nodes, determining resource utilization characteristics of each of the plurality of computing nodes, and estimating energy consumption for each of the plurality of computing nodes in view of the energy consumption profile and resource utilization characteristics of the plurality of computing nodes. The method further includes determining placement of a new workload on one or more of the plurality of computing nodes in view of the estimated energy consumption for each of the plurality of computing nodes and resource requirements of the new workload.

### TECHNICAL FIELD

Aspects of the present disclosure relate to workload scheduling in a computing environment, and more particularly, energy efficient workload placement in a computing environment.

### BACKGROUND

Cloud computing platforms, such as platform-as-a service (PaaS), serverless platforms, etc. can execute computing workloads across one or more physical or virtual computing nodes. Executing a workload results in energy consumption which depends on the requirements of the workload and the hardware on which the workload is being executed.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates an example system for allocating computing workloads for energy efficiency, in accordance with some embodiments.

FIG. 2 is a block diagram that illustrates allocating computing workloads for energy efficiency in accordance with embodiments of the disclosure.

FIG. 3 is a system diagram that illustrates another example system for allocating computing workloads for energy efficiency, in accordance with embodiments of the disclosure.

FIG. 4 is a flow diagram of a method of allocating computing workloads for energy efficiency, in accordance with some embodiments.

FIG. 5 is a flow diagram of another method of allocating computing workloads for energy efficiency, in accordance with some embodiments.

FIG. 6 is a block diagram of an example apparatus that may perform one or more of the operations described herein, in accordance with some embodiments of the present disclosure.

### DETAILED DESCRIPTION

Many companies, financial institutions, etc. may require reporting of energy consumption and emissions data from computing platforms for their own reporting purposes such as to meet obligations to shareholders, commitments to pursuing reduced emissions, and the like. Accordingly, the tracking of carbon emissions (e.g., due to workload energy consumption) through the lifecycle of customer workloads. Additionally, a reduction in the carbon emissions and energy consumption may be desired. Accordingly, the tracking and reduction of workload energy consumption is necessary to meet consumer and business requirements.

Conventional computing platforms include schedulers to perform many functions depending on the function of the platform and desires of the consumer. For example, schedulers may balance workloads across computing nodes to provide maximum performance with respect to the time to perform workloads and to reduce bottlenecks. In some examples, schedulers may maximize the utilization of a particular type or tier of resource to provide a certain level of performance and/or costs. In some examples, schedulers may maximize the efficiency of and utilization of a set of resources. However, these conventional systems do not consider placement of workloads to maximize energy efficiency over the lifetime of executing a computing workload.

Aspects of the disclosure address the above-noted and other deficiencies by providing a workload scheduler using an energy consumption metrics to assist in workload placement on computing nodes of a computing platform. The workload scheduler may obtain an energy consumption profile for hardware types included in the computing nodes of the computing platform. The energy consumption profiles may include power consumption of servers (e.g., hardware) with different workloads at different utilization levels. For example, the energy consumption profiles may indicate power consumption on different hardware with different workloads. The workload scheduler may then generate a correlation model between the energy consumption profiles and utilization characteristics of the types of hardware. The correlation model may be an extrapolation of the profile to provide an estimate of energy consumption of the types of hardware at any resource utilization level.

Upon receiving a new workload to be executed by the computing platform, the workload scheduler determines utilization characteristics for computing nodes of the computing platform. The workload scheduler then estimates a current energy consumption based on the utilization characteristics as well as a potential energy consumption of the computing nodes if the new workload were to be allocated to the computing node. For example, knowing the current utilization characteristics and the estimated current energy consumption of each of the computing nodes, the workload scheduler may determine what an expected energy consumption would be were the new workload be allocated to the computing node in addition to the current workloads being performed. In some examples, the workload scheduler allocates the new workload to the compute node that will result in the least amount of energy consumption to perform the workload (e.g., the most efficient energy computing node).

By providing a workload scheduler to place workloads based on energy efficiency, overall energy consumption of workloads can be reduced and optimized for the computing platform or for workloads of a particular client of the computing platform. Additionally, carbon emissions associated with workloads can be reduced due to the reduced power consumption of the workload.

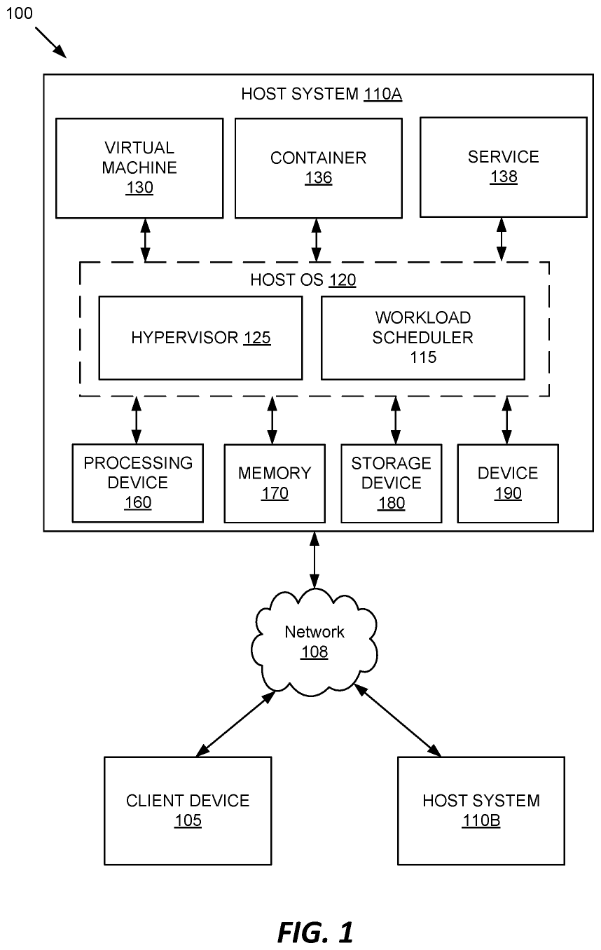

FIG. 1 depicts a high-level component diagram of an illustrative example of a computer system architecture 100, in accordance with one or more aspects of the present disclosure. One skilled in the art will appreciate that other computer system architectures are possible, and that the implementation of a computer system utilizing examples of the invention are not necessarily limited to the specific architecture depicted by FIG. 1.

As shown in FIG. 1, computer system architecture 100 includes host systems 110A-B and client device 105. The host systems 110A-B include one or more processing devices 160, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing devices 160A. It should be noted that although, for simplicity, host system 110A is depicted as including a single processing device 160, storage device 180, and device 190 in FIG. 1, other embodiments of host systems 110A may include a plurality of processing devices, storage devices, and devices. Similarly, client device 105 and host system 110B may include a plurality of processing devices, storage devices, and devices. The host systems 110A-B and client device 105 may each be a server, a mainframe, a workstation, a personal computer (PC), a mobile phone, a palm-sized computing device, etc. In embodiments, host systems 110A-B may be separate computing devices. In some embodiments, host systems 110A-B may be included in a cluster of computing devices. For clarity, some components of client device 105 and host system 110B are not shown. Furthermore, although computer system architecture 100 is illustrated as having two host systems, embodiments of the disclosure may utilize any number of host systems. For example, computer system architecture 100 may include a cluster of computing nodes in which host systems 110A-B are included.

Host system 110A may additionally include one or more virtual machines (VMs) 130, containers 136, and host operating system (OS) 120. VM 130 is a software implementation of a machine that executes programs as though it were an actual physical machine. Container 136 acts as an isolated execution environment for different functions of applications. The VM 130 and/or container 136 may be an instance of a serverless application or function for executing one or more applications of a serverless framework. Host OS 120 manages the hardware resources of the computer system and provides functions such as inter-process communication, scheduling, memory management, and so forth.

Host OS 120 may include a hypervisor 125 (which may also be known as a virtual machine monitor (VMM)), which provides a virtual operating platform for VMs 130 and manages their execution. Hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory. Higher level software may comprise a standard or real-time OS, may be a highly stripped down operating environment with limited operating system functionality, and/or may not include traditional OS facilities, etc. Hypervisor 125 may present other software (i.e., “guest” software) the abstraction of one or more VMs that provide the same or different abstractions to various guest software (e.g., guest operating system, guest applications). It should be noted that in some alternative implementations, hypervisor 125 may be external to host OS 120, rather than embedded within host OS 120, or may replace host OS 120.

The host systems 110A-B and client device 108 may be coupled (e.g., may be operatively coupled, communicatively coupled, may communicate data/messages with each other) via network 108. Network 108 may be a public network (e.g., the internet), a private network (e.g., a local area network (LAN) or wide area network (WAN)), or a combination thereof. In one embodiment, network 108 may include a wired or a wireless infrastructure, which may be provided by one or more wireless communications systems, such as a WiFi′ hotspot connected with the network 108 and/or a wireless carrier system that can be implemented using various data processing equipment, communication towers (e.g., cell towers), etc. The network 108 may carry communications (e.g., data, message, packets, frames, etc.) between the various components of host systems 110A-B and/or client device 105. In some embodiments, host system 110A and 110B may be a part of a computing cluster of a computing platform (e.g., PaaS system).

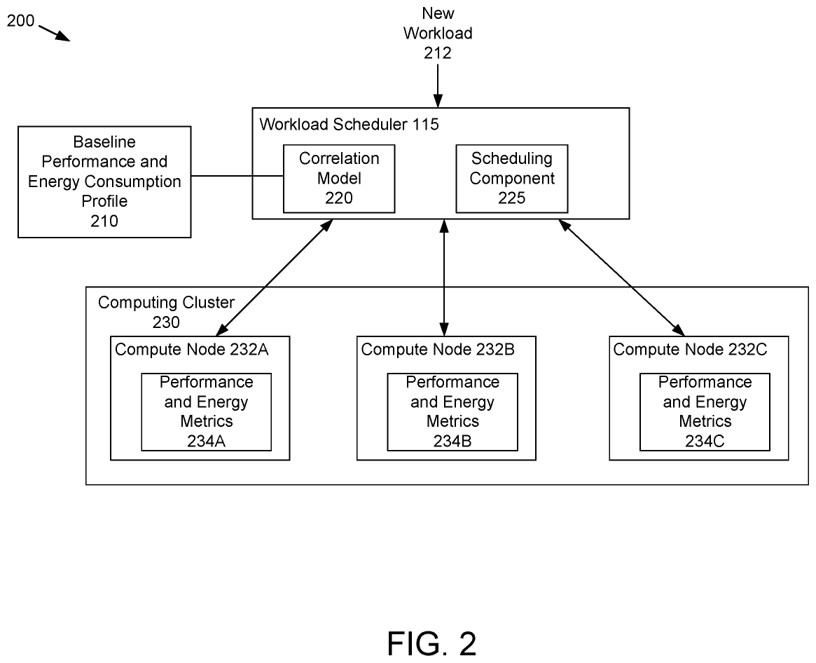

In some examples, host system 110A may include a workload scheduler 115 to schedule and allocate computing workloads to computing nodes of the computing cluster (e.g., among host system 110A-B and any additional host systems of the cluster). The workload scheduler may receive a workload and/or an instruction to execute a workload from client device 105 (e.g., a device of a user or customer of the computing platform). The workload scheduler 115 may determine resource requirements of the workload and allocate the workload to a computing node of the computer system 100 for optimal energy efficiency. In some examples, the workload scheduler 115 may estimate energy consumption that would result from placement of the workload on one or more of the computing nodes of the computing platform. The workload scheduler 115 may then allocate the workload to the computing node estimated to require the least amount of energy to execute the workload. In some examples, the workload scheduler 115 may be included in a container orchestration system of the host system 110A. In some examples, the workload scheduler 115 is included in the host OS 120 of the host system 110A. In some examples, the workload scheduler 115 may execute within a virtual machine 115, container 136, and/or service 138 of the host system 110A. Further details regarding the workload scheduler 115 will be discussed at FIGS. 2-5 below.

FIG. 2 is a block diagram that illustrates a system 200 for allocating computing workloads for energy efficiency, in accordance with some embodiments. In some examples, the system includes a workload scheduler 115. Workload scheduler 115 may be the same or similar to workload scheduler 115 described with respect to FIG. 1. In some examples, the system 200 may further include computing cluster 230 which may include computing nodes 232A-C. Computing nodes 232A-C may each be a server, a mainframe, a workstation, a personal computer (PC), a mobile phone, a palm-sized computing device, or any other computing device. In some examples, compute nodes 232A-C may be coupled via a network (e.g., LAN, WAN, etc.). Although depicted as separate from the computing cluster 230 and the compute nodes 232A-C of the computing cluster 230, the workload scheduler may be included within (e.g., executed by) one of the compute nodes 232A-C. Furthermore, although depicted and described herein as including three compute nodes 232A-C, the computing cluster 230 may include any number of compute nodes.

In some examples, the workload scheduler 115 may schedule workloads on the compute nodes 232A-C based on computing resources available at each of the compute nodes 232A-C. In some examples, the workload scheduler 115 may further allocate the workloads to the compute nodes 232A-C to minimize the power consumed during execution of the workloads. For example, the workload scheduler 115 may identify which of the compute nodes 232A, 232B, or 232C would use the least amount of power to perform a workload and then schedule the workload to the identified compute node.

In some examples, to identify the optimal compute node on which to schedule a new workload 212, the workload scheduler 115 may retrieve baseline performance and energy consumption profile 210. The workload scheduler 115 may generate a correlation model 220 between resource utilization of a computing system and the energy/power consumption of the computing system. For example, the workload scheduler may extrapolate statistics collected from execution of a baseline workload for a computing system (e.g., baseline performance and energy consumption profile) to provide an estimated energy consumption of the computing system for any utilization levels of the hardware of the computing system. The workload scheduler 115 may additionally retrieve performance and energy metrics 234A-C from each of the compute nodes 232A-C upon receiving the new workload 212. The performance and energy metrics 234A-C may include utilization levels of processing resources, memory resources, network resources, and any other computing system resources. In some examples, the workload scheduler 115 may input the performance and energy metrics 234A-C into the correlation model 220 to estimate the current energy consumption of the workloads being performed by the compute nodes 232A-C. The workload scheduler 115 may further input resource requirements indicated by the new workload 212 into the correlation model 220 for each of the compute nodes 232A-C to estimate the energy consumption of each of the compute nodes 232A-C if the new workload 212 were deployed to the compute node (e.g., if the new workload were to be added to the current workloads).

A scheduling component 225 workload scheduler 115 may then identify which compute node 232A-C would consume the least amount of energy to perform the new workload 212 based on the results of the correlation model 220 for each of the compute nodes 232A-C. The scheduler component 225 may then allocate the new workload 212 to the compute node identified to consume the least amount of energy. In some examples, the scheduling component 225 may allocate the new workload 212 based on both performance of the workload (e.g., how quickly the workload can be performed) as well as the energy consumption of the workload. Thus, the scheduling component 225 may balance allocation to meet a minimum performance threshold while also minimizing energy consumption for executing the new workload 212.

It should be noted that while a single correlation model 220 is described above, any number of correlation models may be generated for different computing systems and different computing hardware. Additionally, the workload scheduler 115 may apply the correlation model corresponding to the computing system and computing hardware of each of the different compute nodes of the computing cluster.

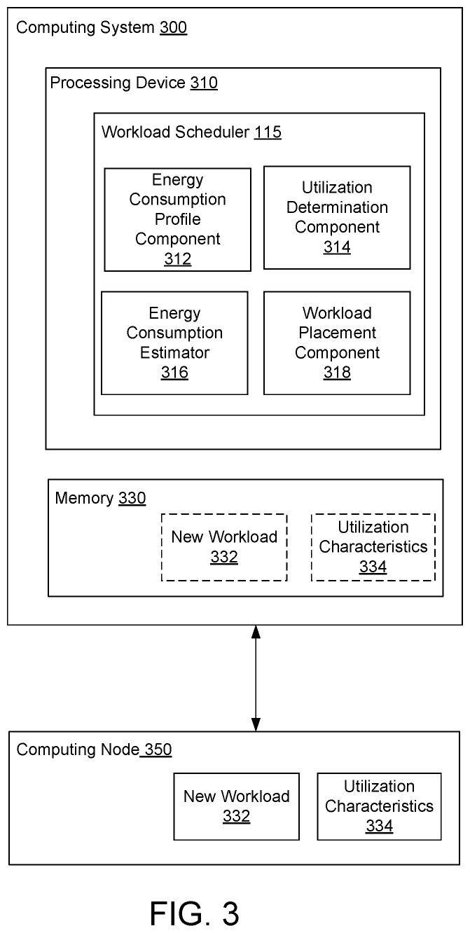

FIG. 3 is a block diagram that illustrates a computing system 300 for allocating workloads to computing nodes for energy efficiency, according to some embodiments. Computing system 300 may include a processing device 310 and memory 330. Memory 330 may include volatile memory devices (e.g., random access memory (RAM)), non-volatile memory devices (e.g., flash memory) and/or other types of memory devices. Processing device 310 may be a central processing unit (CPU) or other processing device of computing system 300. Computing device 300 may be coupled to a computing node 350. The computing node 350 may be one of several computing nodes of a computing cluster.

In one example, the processing device 310 may execute a workload scheduler 115 to determine where a new workload is to be allocated. The workload scheduler 115 may include an energy consumption profile component 312, a utilization determination component 314, an energy consumption estimator 316, and a workload placement component 316. The energy consumption profile component 312 may retrieve or otherwise obtain one or more energy consumption profiles for computing systems executing a baseline workload. For examples, the energy consumption profiles may include the energy consumption of a type of computing system and the utilization and performance characteristics of the computing system while executing a benchmark workload. The utilization determination component 314 may query each computing node (e.g., computing node 350) of the computing cluster to determine utilization characteristics 334 of the computing nodes. In some examples, the utilization determination component 314 may determine the utilization characteristics when the workload scheduler 115 receives a new workload 332 to be executed by the computing cluster. The utilization characteristics may include utilization levels of processing resources, memory resources, and network resources. In some examples, the utilization characteristics may also include data retrieval patterns such as access to from caches of the processor, accesses to memory, and accesses to storage. In some examples the utilization characteristics may include metrics retrieved from hardware performance counters of the computing resources (e.g., processors, memory, etc.) of the computing nodes.

The energy consumption estimator 316 may estimate, based on the utilization characteristics 334, both the current energy consumption of the computing nodes as well as the potential energy consumption of the computing nodes if the new workload 332 is deployed to the computing node. For example, the energy consumption estimator 316 may determine a total resource utilization of the computing nodes based on the current utilization characteristics 334 and resource requirements of the new workload 332. The new workload 332, for example, may include an indication of the resources to be allocated to execute the new workload 332. Thus, the energy consumption estimator 316 may estimate the energy consumption based on the total utilization of the computing nodes if the new workload 332 were to be deployed at that node. The workload placement component 318 may then determine which of the computing nodes of the cluster would consume the least amount of energy to perform the new workload 332. The workload placement component 318 may then allocate the new workload 332 to the identified computing node 350. The computing node 350 may then execute the new workload 332.

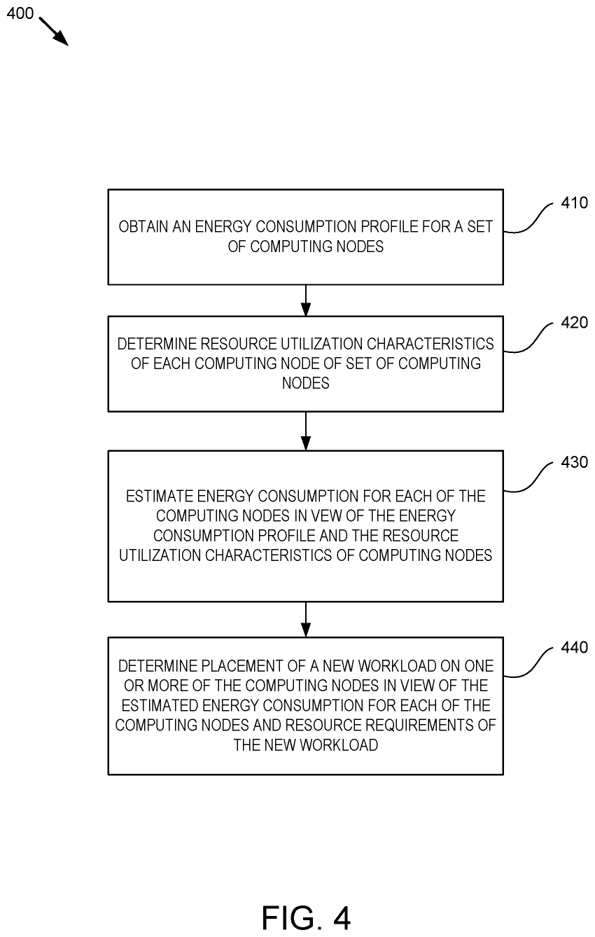

FIG. 4 is a flow diagram of a method 400 of allocating workloads to computing nodes based on energy efficiency, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by workload scheduler 115 of FIGS. 1-3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic obtains an energy consumption profile for a set of computing nodes. For example, the processing logic may retrieve an energy consumption profile for a computing system type and/or hardware type for each of the computing nodes of a cluster of computing nodes. Thus, if a computing cluster includes multiple types of computing systems or different computing hardware, multiple energy consumption profiles may be retrieved (e.g., one for each system or hardware type). In some examples, each energy consumption profile may include energy consumption metrics, computing resource utilization metrics, performance metrics, etc. collected during execution of one or more benchmark workloads on a particular type of system. The energy consumption profiles based on the benchmark workloads may be generated external to the computing cluster. In another example, the energy consumption profile(s) may be generated by running a benchmark workload on one or more of the computing nodes of the cluster.

At block 420, the processing logic determines resource utilization characteristics of each of the computing nodes. In some examples, the processing logic may query each of the computing nodes in the cluster to retrieve utilization characteristics. The utilization characteristics may include resource utilization metrics, performance metrics, etc. (e.g., from performance/hardware counters) of the computing clusters. For example, the utilization characteristics may include utilization levels of processing resources, memory resources, and network resources. In some examples, the utilization characteristics may also include data retrieval patterns such as access to from caches of the processor, accesses to memory, and accesses to storage. The data access patterns may affect the energy consumed by a workload (e.g., higher access to memory and storage result in more energy usage). In some examples, the processing logic continuously monitors the utilization characteristics. In other examples, the processing logic may retrieve the resource utilization characteristics from the computing nodes in response to determining that a new workload is to be executed by the cluster. For example, a workload scheduler of the cluster may receive a new workload and then retrieve the resource utilization characteristics.

At block 430, the processing logic estimates energy consumption for each of the computing nodes in view of the energy consumption profile and resource utilization characteristics of the computing nodes. In some examples, the processing logic may generate a correlation model for each of the computing system or hardware types. The correlation model may extrapolate the correlation between resource utilization and energy consumption. Accordingly, the processing logic may input the resource utilization characteristics into the correlation models (e.g., the correlation model corresponding to the system and hardware type for each of the computing nodes) to estimate an energy consumption of computing nodes. In some examples, the processing logic may additionally factor in the resource requirements of the new workload to estimate a total energy consumption for each computing node if the computing node were to be allocated to the computing node. For example, the processing logic may add the resource requirements of the new workload to the resource utilization characteristics of the computing nodes and then plug these updated numbers into the correlation model to estimate the potential energy consumed by the computing nodes to execute the new workload.

At block 440, the processing logic determines placement of the new workload on one or more of the computing nodes in view of the estimated energy consumption for each of the computing nodes and resource requirements of the new workload. For example, the processing logic may allocate the new workload to the computing node that is estimated to use the least amount of energy to execute the new workload. In some examples, the processing logic may place the new workload to balance performance and energy consumption. For example, the processing logic may place the new workload to meet a minimum performance threshold and also minimize energy consumption for the new workload. The processing logic may place the workload in any manner to track and reduce energy consumption for the new workload.

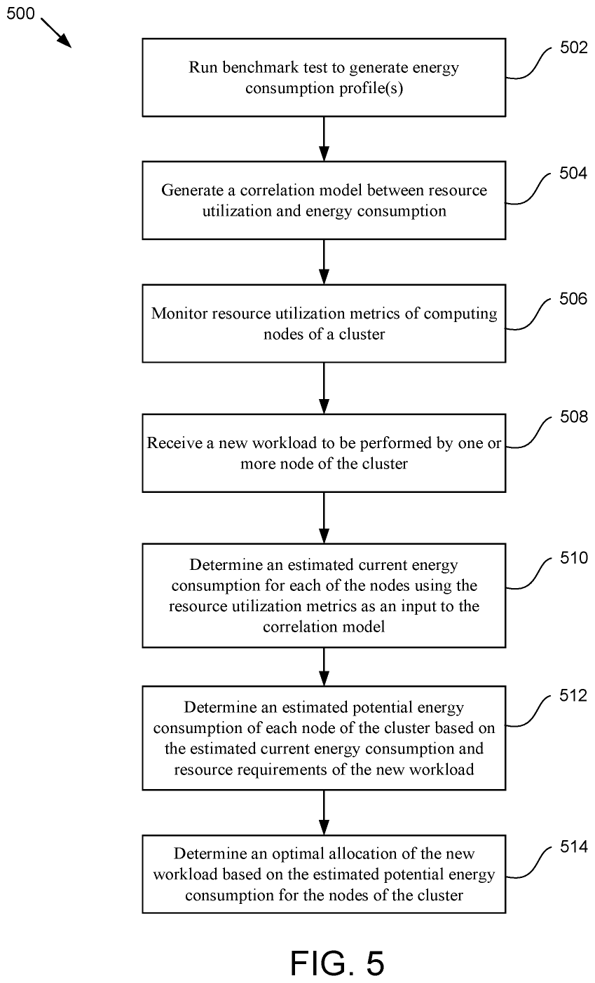

FIG. 5 is a flow diagram of a method 500 of allocating workloads to computing nodes based on energy efficiency, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by workload scheduler 115 of FIGS. 1-3.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 502, where the processing logic runs a benchmark test to generate energy consumption profiles for one or more computing systems and/or computer hardware types. The benchmark tests may be performed outside or within the cluster of computing nodes. The statistics include in the energy consumption profiles may include, but are not limited to, processor utilization, processor instruction cycles, cache utilization, cache misses, memory utilization, memory load times, energy consumption and thermal temperature. The processing logic may also collect performance metrics, such as network performance, disk performance, etc.

At block 504, the processing logic generates a correlation model between resource utilization and energy consumption. For example, the correlation model may be a regression of the resource utilization statistics to determine energy efficiency. The energy efficiency may be in terms of performance per watts (e.g., work performed per energy consumed).

At block 506, the processing logic monitors resource utilization metrics of computing nodes of a cluster. The resource utilization metrics may be the same statistics as those collected at block 502 for the energy consumption profile. At block 508, the processing logic receives a new workload to be performed by one or more nodes of the cluster.

At block 510, the processing logic determines an estimated current energy consumption for each of the nodes in the cluster using the resource utilization metrics as inputs to the correlation model. At block 512, the processing logic determines an estimated potential energy consumption of each node of the cluster based on the estimated current energy consumption and resource requirements of the new workload. The processing logic may use the correlation model to predict the node with the highest energy efficiency. For example, the correlation model may include a regression model which uses the baseline statistics from the energy consumption profile and the compute node metrics to determine the energy efficiency of the computing nodes.

At block 514, the processing logic determines an optimal allocation of the new workload based on the estimated potential energy consumption for each of the nodes of the cluster. In some examples, the processing logic may determine which of the compute nodes includes the highest energy efficiency to place the workload. The processing logic may then place the new workload at the determined highest energy efficiency compute node to be performed.

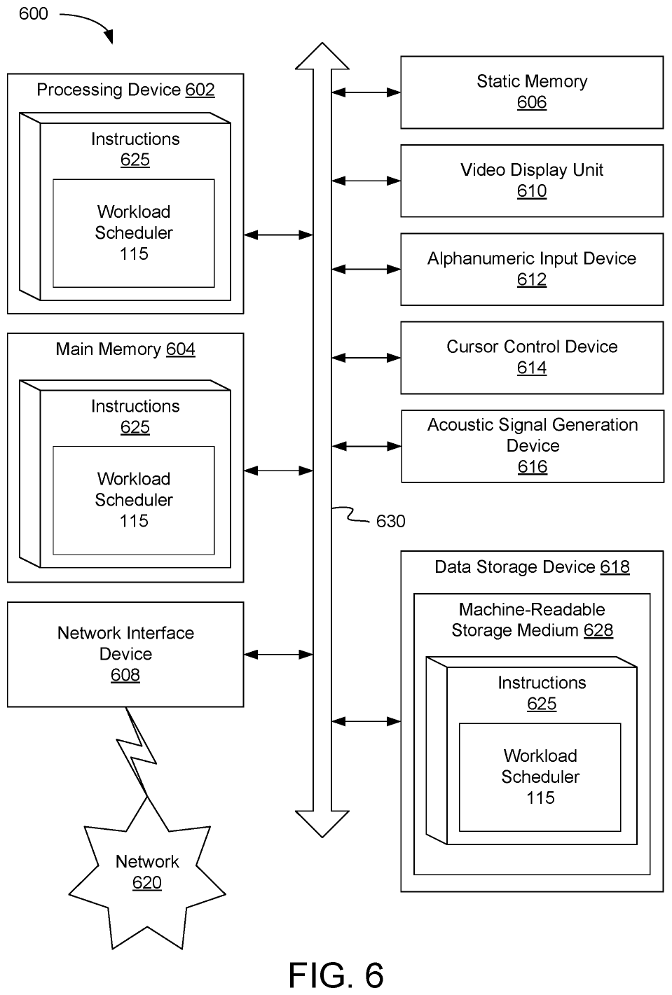

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a workload scheduler, e.g., workload scheduler 115, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
obtaining an energy consumption profile for a plurality of computing nodes;
determining resource utilization characteristics of each of the plurality of computing nodes;
estimating, by a processing device, energy consumption for each of the plurality of computing nodes in view of the energy consumption profile and the resource utilization characteristics of the plurality of computing nodes; and
determining, by the processing device, placement of a new workload on one or more of the plurality of computing nodes in view of the estimated energy consumption for each of the plurality of computing nodes and resource requirements of the new workload.

2. The method of claim 1, further comprising:
generating a correlation model between energy consumption and resource utilization levels based on the energy consumption profile.

3. The method of claim 2, wherein estimating energy consumption for each of the plurality of computing nodes comprises:
applying the correlation model to the resource utilization characteristics of the plurality of computing nodes.

4. The method of claim 1, wherein the resource utilization characteristics comprise:
utilization levels of processing resources, memory resources, and network resources.

5. The method of claim 4, wherein the resource utilization characteristics further comprise:
data retrieval patterns from caches of processing resources, memory resources, and storage resources.

6. The method of claim 1, wherein determining the placement of the new workload comprises:
determining a computing node of the plurality of computing nodes that will result in the least amount of energy consumption to perform the new workload.

7. The method of claim 1, wherein the energy consumption profile comprises a standard benchmark profile for a computing system generated by executing a benchmark workload on the computing system.

8. A system comprising:
a memory; and
a processing device operatively coupled to the memory, the processing device to:
obtain an energy consumption profile for a plurality of computing nodes;
determine resource utilization characteristics of each of the plurality of computing nodes;
estimate energy consumption for each of the plurality of computing nodes in view of the energy consumption profile and the resource utilization characteristics of the plurality of computing nodes; and
determine placement of a new workload on one or more of the plurality of computing nodes in view of the estimated energy consumption for each of the plurality of computing nodes and resource requirements of the new workload.

9. The system of claim 8, wherein the processing device is further to:
generate a correlation model between energy consumption and resource utilization levels based on the energy consumption profile.

10. The system of claim 9, wherein to estimate energy consumption for each of the plurality of computing nodes, the processing device is to:
apply the correlation model to the resource utilization characteristics of the plurality of computing nodes.

11. The system of claim 8, wherein the resource utilization characteristics comprise:
utilization levels of processing resources, memory resources, and network resources.

12. The system of claim 11, wherein the resource utilization characteristics further comprise:
data retrieval patterns from caches of processing resources, memory resources, and storage resources.

13. The system of claim 8, wherein to determine the placement of the new workload, the processing device is to:
determine a computing node of the plurality of computing nodes that will result in the least amount of energy consumption to perform the new workload.

14. The system of claim 8, wherein the energy consumption profile comprises a standard benchmark profile for a computing system generated by executing a benchmark workload on the computing system.

15. A non-transitory computer-readable storage medium including instructions that, when executed by a processing device, cause the processing device to:
obtain an energy consumption profile for a plurality of computing nodes;
determine resource utilization characteristics of each of the plurality of computing nodes;
estimate, by the processing device, energy consumption for each of the plurality of computing nodes in view of the energy consumption profile and the resource utilization characteristics of the plurality of computing nodes; and
determine, by the processing device, placement of a new workload on one or more of the plurality of computing nodes in view of the estimated energy consumption for each of the plurality of computing nodes and resource requirements of the new workload.

16. The non-transitory computer-readable storage medium of claim 15 wherein the processing device is further to:
generate a correlation model between energy consumption and resource utilization levels based on the energy consumption profile.

17. The non-transitory computer-readable storage medium of claim 16, wherein to estimate energy consumption for each of the plurality of computing nodes, the processing device is to:
apply the correlation model to the resource utilization characteristics of the plurality of computing nodes.

18. The non-transitory computer-readable storage medium of claim 15, wherein the resource utilization characteristics comprise:
utilization levels of processing resources, memory resources, and network resources.

19. The non-transitory computer-readable storage medium of claim 18, wherein the resource utilization characteristics further comprise:
data retrieval patterns from caches of processing resources, memory resources, and storage resources.

20. The non-transitory computer-readable storage medium of claim 15, wherein to determine the placement of the new workload, the processing device is to:
determine a computing node of the plurality of computing nodes that will result in the least amount of energy consumption to perform the new workload.
